(19) United States
(12) Patent Application Publication
(10) Pub. No.: US 2006/0133768 A1
(43) Pub. Date: Jun. 22, 2006

(54) Methods and apparatus for tracking consumer preferences in a video rental system

(76) Inventor: Aubrey Judson Ellis JR., Winnetka, IL (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 11/018,949

(22) Filed: Dec. 21, 2004

(51) Int. Cl. H04N 5/93

(52) U.S. Cl. 386/52

(57) ABSTRACT

Apparatus and methods for gathering information about a customer's preferences, storing the customer's preferences in a memory, selecting informational content to be added to the rented video medium based upon the customer's preferences, adding the selected informational content to the rented video medium, extracting customer information from the rented video medium upon its return; storing of the extracted customer information in a memory and preparing reports that include the number of times that the informational content was viewed by customers. The customer may also respond interactively to the added informational content.

### FIELD OF THE INVENTION

The present invention relates generally to methods and apparatus for tracking consumer preferences. More particularly, the invention relates to methods and apparatus for determining consumer preferences and adding informational content to a video and/or digital medium that more closely tracks the interests of each consumer.

### BACKGROUND OF THE INVENTION

A series of advertisements typically precedes the showing of a movie at a motion picture theatre. These advertisements are known in the art as trailers. Such trailers may include advertisements for new movies that will be released in the near future, advertisements for snacks and beverages available at the theatre and general advertisements for vehicles, other consumer goods and the like. These advertisements are often general in nature and are not specifically tailored or targeted to the interests of any particular theatre attendee or consumer.

In a similar manner, video rental stores rent movies that are prerecorded on a video medium, such as in the current digital video disk (DVD) format. These rental movies may also have informational trailers that precede the selected or rented movie. However, as the DVD becomes older, certain informational trailers may become out-dated or otherwise of lesser value or interest. Many customers often fast forward their video equipment to skip over the advertising trailers recorded onto the video medium that precede the movie of interest because such advertisements are of little or no interest to them. Of course, when the customer brings the selected movies to the checkout counter of the video rental store, there is typically no time for the rental store to update or customize the informational content on the video medium prior to checking the movies out.

More recently, video rental services that rent several movies at a time for a period of about a month before requiring return have enjoyed popularity with a certain segment of the movie rental community. One such example is NetFlix, which maintains an internet site at www.netflix.com. Other competitors also presently exist. For example, this service may offer all the movies that a customer wishes to see during the course of a month for a flat rate. Desired titles are selected from the listing of available movies. A fixed number of movies are then sent by mail or other delivery service to the customer. Each movie will be on a separate DVD. When the customer has viewed the movies, the movies are returned by mail and the rental service sends another fixed number of previously selected titles to the customer.

Thus, there has been a long-felt need for a more effective means of tracking the interests of customers and recording onto the video or digital medium advertisement trailers and/or other informational content that is tailored to the interests of the specific customer.

Accordingly, it is a general object of the present invention to provide methods and apparatus for tracking the interests of customers to tailor advertising trailers and/or other informational content to more closely match the interests of each customer.

Another object of the present invention is to prerecord informational content of interest to the customer onto the video or digital medium with the selected movie.

Yet another object of the present invention is to provide a prerecorded video medium that contains advertising trailers or informational content that are selected to track the interests of each customer.

A further object of the present invention is to extract viewer information from the video medium and to use the extracted information to prepare reports, such as on the number of times that the informational content has been viewed.

A still further object of the present invention is to enable the user to provide feedback to the rental service.

Another object of the present invention is to provide the user with interactive experiences, such as entry into sweepstakes, contests and the like.

### BRIEF SUMMARY OF THE INVENTION

This invention is directed to methods of adding informational content to rented video medium, including the steps of gathering information about a customer's preferences, storing the customer's preferences in a memory, selecting informational content to be added to the rented video or digital medium based upon the customer's preferences and adding the selected informational content to the rented video medium. The added informational content may include advertising trailers.

The step of selecting informational content to be added to the rented video media is based upon selection criteria, which may include customer specific data, data from similar customer profiles or other data such as demographic data derived from zip codes or the like. As additional rentals occur, the customer profiles continue to be updated.

Additional steps of the methods may include extracting customer information from the rented video or digital medium upon its return, storing of the extracted customer information in a memory and preparing reports that include the number of times that the informational content was viewed by customers.

The present invention is further directed to apparatus for adding informational content to a rented video medium. The apparatus may include a data processor for gathering information about a customer's preferences, a customer database for storing the customer's preferences, a content database for storing informational content and apparatus for adding the selected informational content to the rented video or digital medium. The data processor selects informational content from the content database to be added to the rented video medium based upon the customer's preferences. The informational content may include advertising trailers. The informational content added to the rented video medium is based upon selection criteria, which may include customer specific data, preference data supplied by the customer, data on the types of movies previously rented, data from similar customer profiles and/or demographic data based upon zip codes or the like.

The system may include a data processor for extracting customer information from the rented video medium upon its return of the video rental medium and the extracted customer information may be stored in the customer database. The extracted information may include the number of times that the informational content was viewed by customers. The selected informational content may be added to the rented video or digital media by a DVD burner.

The present invention is also directed to a rental video or digital medium containing a plurality of prerecorded informational content segments, the segments selected based upon a customer's preferences and at least one movie segment. The plurality of prerecorded informational content segments may include advertising trailers.

The present invention further includes methods of enabling a customer to interactively respond to added informational content in a rented video medium, including the steps of adding informational content to the rented video medium; presenting the customer with a menu of options upon playing of the added informational content; and selecting one of the options in the menu by the customer. Additional steps may include gathering information about the customer's preferences; storing the customer's preferences in a memory; and selecting informational content to be added to the rented video medium based upon the customer's preferences. Options in the menu may include purchasing a product or service, linking to a website and/or printing a coupon. Interactive selections made by the customer may be communicated to the provider of the rented video medium.

### BRIEF DESCRIPTION OF THE DRAWINGS

The features of the present invention which are believed to be novel are set forth with particularity in the appended claims. The invention, together with the further objects and advantages thereof, may best be understood by reference to the following description taken in conjunction with the accompanying drawings, in the figures in which like reference numerals identify like elements, and in which:

FIG. 1 is a flow chart illustrating the various steps of the methods that may be used to determine the preferences of customers and for adding information content onto a video medium in accordance with the present invention;

FIG. 2 illustrates a system that may be used to determine the preferences of customers and for adding information content onto a video or digital medium in accordance with the present invention;

FIG. 3 illustrates a prerecorded video or video medium with a plurality of informational content segments that may be selected in accordance with the customer's preferences and at least one movie segment;

FIG. 4 illustrates a system through which the customer may interactively communicate with the vendor's system shown in FIG. 2;

FIG. 5 is a flow chart illustrating the various steps that the customer may use when interacting with the added informational content on the video medium shown in FIG. 3; and

FIG. 6 is a flow chart that supplements the flow chart of FIG. 5 and that illustrates additional steps that the customer may use when interacting with the added informational content on the video medium shown in FIG. 3.

### DESCRIPTION OF THE PREFERRED EMBODIMENT

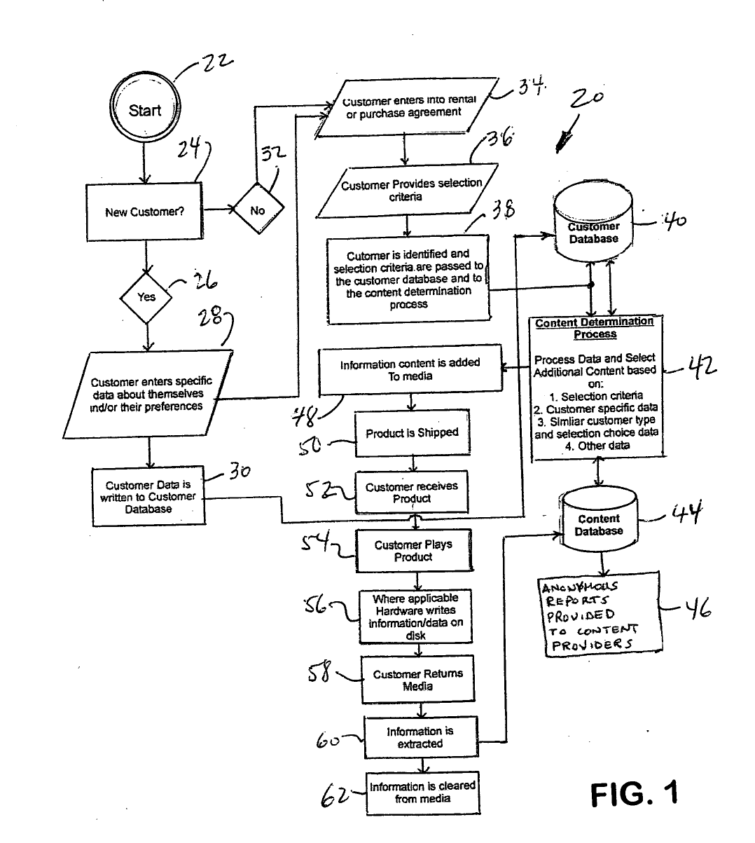

FIG. 1 is a flow chart, generally designated 20, of exemplary steps and techniques utilized in the present invention to determine the preferences of a customer and to insert informational content onto a video or digital medium that is customized to better track the interests of each customer. After starting at Start bubble 22, the customer is identified at block 24. For example, the customer may start by logging onto a website from a computer with an email address and by entering a password. It is then determined if the customer is a new customer or a known customer.

If the customer is determined to be a new customer at block 26, the customer may be presented with a screen that requests further information, including preferences. Such preferences may relate to lifestyle, income levels, and personal characteristics, such as age, sex, marital status, preferred activities, hobbies, preferred types of music and the like. Further preferences may define preferred types of movies, such as drama, western, comedy, educational, horror, sports, documentary, science fiction, educational, health and fitness, action and adventure, x-rated, and the like. Of course, requested information may also include credit card information for billing purposes. At block 30, the information entered by the customer is sent to a database, such as customer database 40, for storage. Such preference information may be recalled at later times, as needed.

After the customers enter the requested information and/or their preferences at block 28, the next screen to appear on their computer may be a rental or purchase agreement, as indicated at block 34. Of course if the customer was previously identified as an existing customer at block 32, he/she may be asked at block 34 to reaffirm a prior rental or purchase agreement.

After complying with the agreement formalities in block 34, the customer enters his/her selections for the movies that are desired in block 38. Based upon the previously entered preferences, the customer may also be provided with suggestions for rental, such as recently issued movies that are consistent with the customer's entered preferences that are stored in customer database 40. The customer information is then stored in the customer database 40 and the process proceeds to the content determination process block 42.

The content determination process in block 42 determines the information content that is to be added to the rented movie prior to sending the movie to the customer. The type of content to be added may depend upon one or more criteria. For example, the first criterion may be based upon the movie selections made by the consumer, either during the current selections or based upon prior movie selection data. The second criterion may be customer specific data, such as relating to one or more customer preferences previously entered. The third criterion may be based upon data stored in the customer database 40 for customers with similar preference profiles. Lastly, other types of data may be used, such as demographic data that may include the customer's zip code or the like. Other or alternate criteria may be utilized, if so desired. These criteria may be used separately or individually in determining the information content to add to the movie. The various criteria may also be combined or weighted, if so desired, to determine the information content to be added to the movie prior to sending it to the customer. For example, if the customer indicated a preference for foreign automobiles, the added information content to the movie may consist of one or more advertisements of foreign automobiles. Similarly, if the customer indicated that he/she was computer proficient or interested in high technology devices, the added information content may include advertising of a technology device or apparatus. The added information content may also include soon to be released movies of a similar type to those rented by the identified customer. Many other variations will be apparent to those skilled in the art.

A content database 44 contains all of the different types of information content, including advertising trailers that are available for adding to the medium that contains the rented movie. After selection of the information content to be added to the video medium in accordance with the content determination process of block 42, the selected information content is downloaded from content database 44 and added, burned or recorded onto the video medium at block 48, such as onto a DVD. This may be accomplished by adding the selected information content to a medium, such as to a DVD, which already contains one of the movies of interest. Alternatively, if permitted, the selected information content may be added with the movie of interest to the desired medium. Of course, the selected information content could similarly be determined and added prior to playing of selected movies on television, such as from a signal from a cable provider or from a signal from a satellite system.

The video medium with the added informational content that is created at block 48 may be a DVD that is returnable. Alternatively, the video medium or DVD may contain coding that prevents further use of the disk after a predetermined date, such as 30 days after the rental. The customer will then likely dispose of the DVD when it becomes unplayable. Of course a disk which becomes unplayable after a predetermined date may not typically require return to the rental service.

After the informational content is added to the video medium at block 48, the video medium is shipped at block 50, received by the customer at block 52 and played by the customer at block 54. Upon viewing of the added content, the customer may interactively respond to invitations to enter sweepstakes, contests or the like. For example, if the customers viewing equipment is connected to a computer, the added content may contain a URL that takes the customer to an internet site. Other forms of interactivity may include obtaining further information on any of the goods or services that are shown in the added content, purchasing any of the advertised goods or services, providing discounts or coupons for the goods or services shown in the added content, and the like.

If the customer's video equipment has the capability of recording or writing information onto the video or digital medium, further information or data may be recorded or written onto the video medium at block 56. Such recording or writing capabilities may permit the customer to add content onto the DVD that can be added to the customer database 40. For example, the further information may also include how many times the video medium was played or viewed and whether the added informational content was viewed, skipped, or the like. If the video medium is returned, such as at block 58, the information added by the customer's equipment is extracted at block 60 and provided to the content database 44. If the video medium is reusable, the added information content and the information added by the customer's equipment may be cleared or erased prior to reuse, as at block 62.

As indicated at block 46, reports may be issued from the content database 44. For example, reports may be issued to the providers of advertisements that include the number of times that any specific advertisement was added to a video medium, whether the advertisement was actually viewed by the customer, and, if so, the number of times that the advertisement was viewed. Rather than providing specific information on any identifiable customer, such reports may be anonymous or summary in nature. This may also assist in compliance with any applicable privacy rules or laws. Even if the customer's equipment does not record extractible information onto the video or digital medium, such reports may indicate the number of times that any particular advertisement was added to the content of video medium. These reports may also provide a basis for determining the amount of advertising expense to be charged to the respective advertisers.

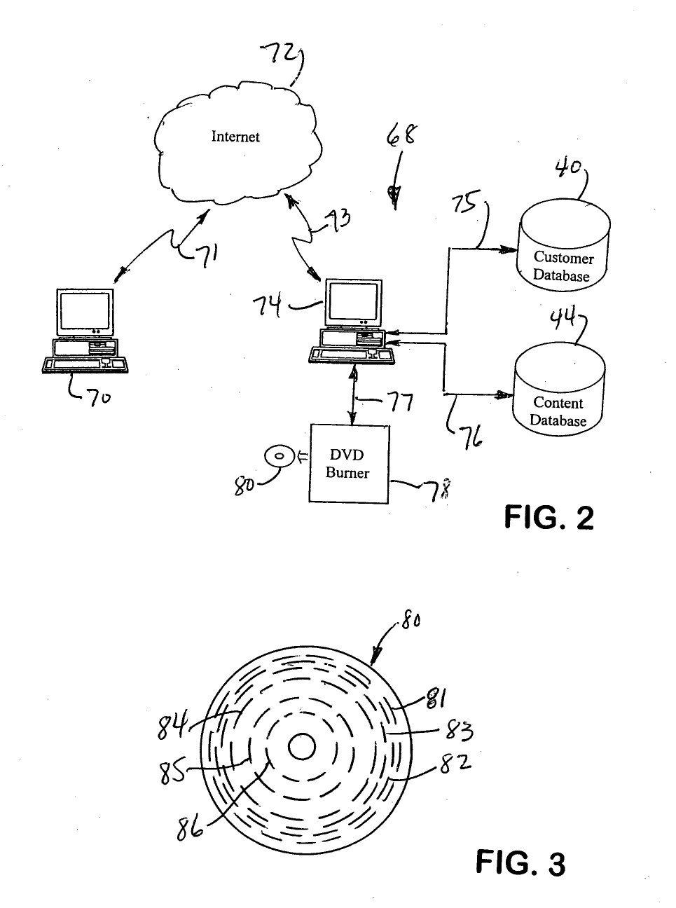

FIG. 2 illustrates a system, generally designated 68, for determining the preferences of customers and for adding information content onto a video or digital medium in accordance with the present invention. A customer may log onto a website from his/her computer 70 via a connection 71 to the Internet 72 to view one or more pages presented by the rental service's computer 74 via another connection to the Internet. Internet connections 71 and 73 may be any type of connection suitable for accessing the Internet, including a dial-up modem, a high-speed broadband connection, a satellite or radio frequency link or the like. Vendor's computer 74 may be any type of computer or data processor suitable for maintaining an Internet website, such as one or more servers, computers or the like.

The rental service's computer 74 is also adapted to carry out many of the steps in the above described methods, including, inter alia, gathering information about a customer's preferences (block 28 of FIG. 1), storing the customer's preferences in a memory (such as in customer database 40, block 30 of FIG. 1), selecting informational content to be added to the rented video medium based upon the customer's preferences (such as from content database 44, block 42 in FIG. 1), extracting customer information from the rented video medium upon return of the rented video medium (block 60 of FIG. 1), storing of the extracted customer information in a memory (block 60 of FIG. 1) and preparing reports that include the number of times that the informational content was viewed by customers (block 46 of FIG. 1). To these ends, computer 74 bi-directionally communicates with customer database 40 via one or more lines 75 and bi-directionally communicates with content database 44 via one or more lines 76.

Customer database 40 and content database 44 can be separate databases as shown in FIGS. 1 and 2, or may be parts of other databases. Databases 40 and 44 may also be part of a box office database or a video on demand database. If databases 40 and 44 are part of a box office or video on demand database, the added informational content may be spontaneously determined and added to the viewing experience as the video information is beginning to be supplied to the customer.

The rental service's computer further bi-directionally communicates via one or more lines 77 with an apparatus for adding the information content to a rental video medium. For example, the apparatus for adding the selected informational content may be a DVD burner 78 and the rental video or digital medium may be a DVD 80.

FIG. 3 illustrates a DVD created in accordance with the present invention by the system 68. DVD 80 includes a plurality of tracks or segments 81-83 of added informational content that are selected in accordance with the customer's preferences by system 68, such as at block 42 of FIG. 1. These tracks or segments 81-83, hereinafter “segments”, of informational content may number from one to several or more segments. Where applicable, tracks 81-83 of added informational content may be peaks and valleys of landscapes that allow for significantly greater storage of informational content. Moreover, one of the segments, such as segments 81-83, may include a computer program to manage the monitoring of the viewing habits of the customer and that also manages the provision of feedback to the content database 44 concerning the customer's viewing and interaction with the added informational content. For example, the computer program may keep track of the number of times that the customer has viewed the added informational content.

The amount of time to view these segments may typically be in a range of about 5 to 15 minutes. If the time to view the segments is greater than about 15 minutes, many viewers have a tendency to want to skip or fast forward over these informational content segments to begin immediate viewing the movie that was rented. For example, in FIG. 3, the movie may begin at track 84 and extend to track 85. Of course, where the capacity of the DVD permits, more than one movie may be recorded onto DVD 80.

In accordance with another aspect of the present invention, the customer's video equipment may be capable of recording or adding onto DVD 80, information about the viewing of the DVD. For example, this may include whether the customer viewed the information content on segments 81-83 and, if so, how many times each segment 81-83 was viewed, as in accordance with block 56 of FIG. 1. In accordance with block 60 of FIG. 1, this viewing information can then be extracted by the rental service upon return of the rented DVD, stored in content database 44 and reports may be prepared to content providers or advertisers on the viewing of their advertisements or the like, as shown in block 46 of FIG. 1.

While the DVD 80 has frequently been described as having video content in the form of a movie, it will be appreciated that DVD 80 may contain a digital game. Digital games are also frequently rented at movie rental services. Of course, such a digital game contains both video content and digital program content. It will be further appreciated that while the movies and/or games have video content, such video content is recorded onto the DVD as digital data. Thus, while the expression “video content”, or the like, is used herein, it is understood that the digital data in the form of a movie or game is recorded onto the DVD by the rental service and that this digital data on the DVD is then converted back into the form of a movie or game by the customer's playback device.

It will be appreciated that the form of the preferred video medium changes with time. Presently, the former VCR tapes are rapidly being phased out in favor of DVDs. While DVDs are contemplated as the preferred form of the video rental medium in this patent application, and as illustrated in FIG. 3, it will be further appreciated that video rental mediums are likely to continue evolving. Accordingly, the expression “video rental medium”, as used herein, is not intended to be limited to DVDs. Instead, the expression video rental medium is intended to be broadly construed to include future media that is used in connection with video rentals. For example, future formats that may replace the current DVD include High-Definition DVD and Blu-ray technology.

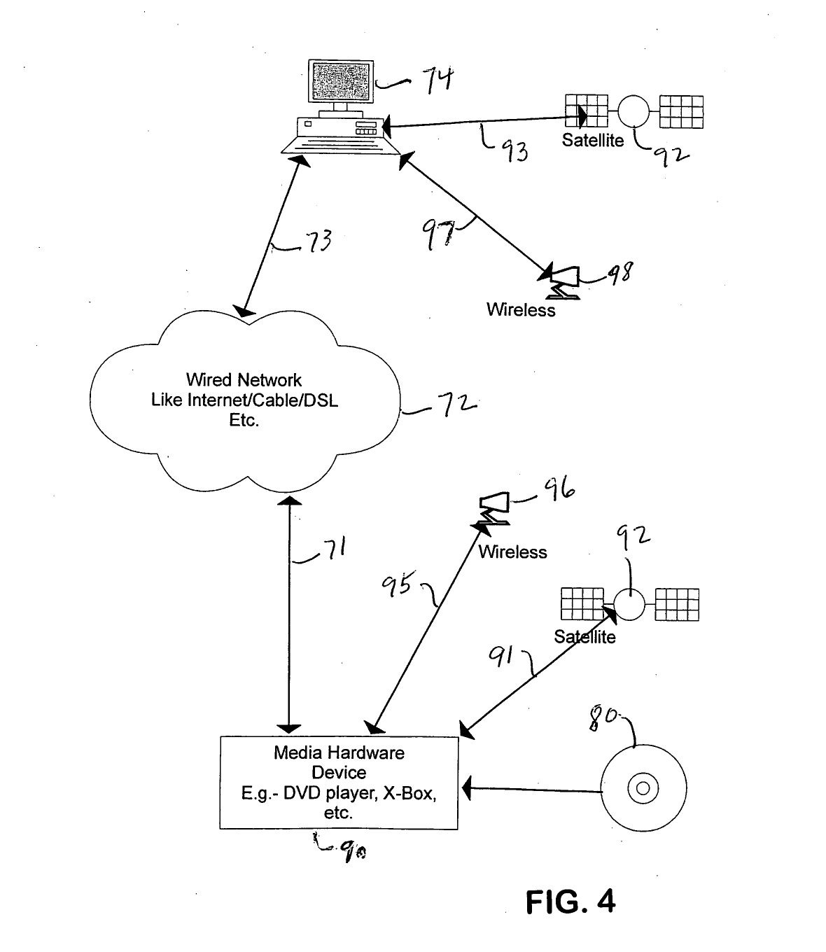

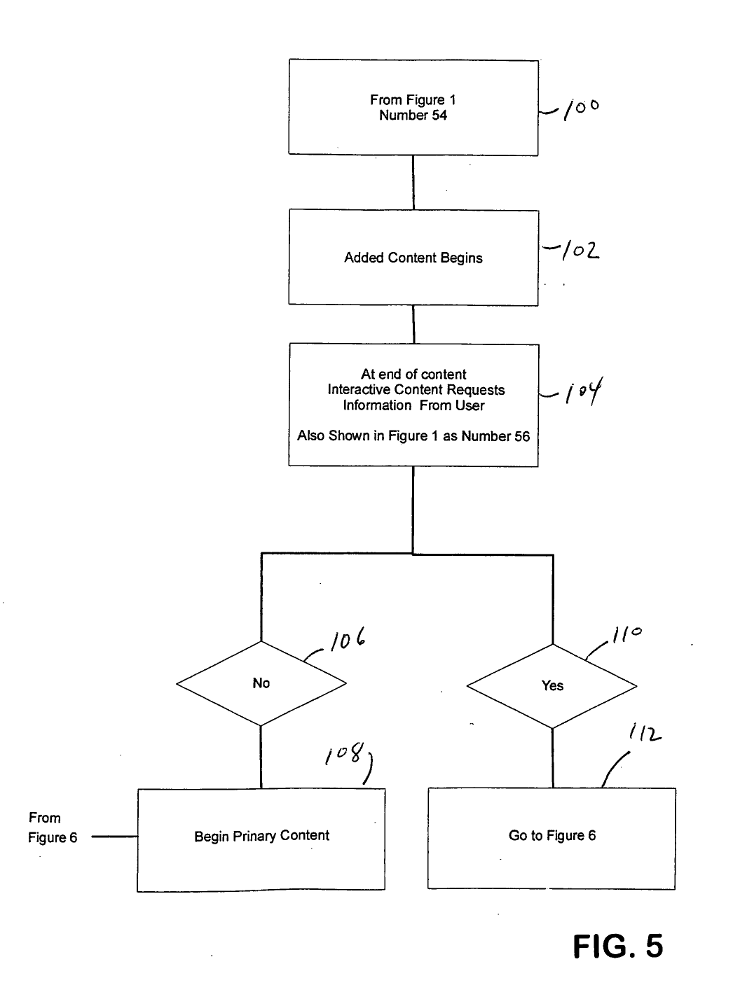

As shown in FIG. 4, the customer's media hardware device 90, that plays the DVD 80 may also interactively communicate with the rental service's computer 74 in any of a plurality of different ways. For example, the customer's playback device for playing the DVD 80 may communicate by a computer connection 71 to the internet 72 and then by a computer connection 73 to the rental services computer 74. Computer connections 71, 73 may be by rented DSL line, by fiber optic lines, by a broadband cable service, by modem connection to the public telephone network, or the like. Media hardware device 90 may also communicate by a radio frequency link, such as by a link 95 to a wireless device 96 and/or by a link 97 from a wireless device 98 to computer 74. For example, radio frequency links 95 or 97 may be by the IEEE 802.11b Wi-Fi standard. Similarly, media hardware device 90 may communicate by a satellite communication link 91 to a satellite 92 and then by another link 93 from satellite 92 to computer 74. Various other kinds of network connections or the like may be employed, as desired.

The media hardware device 90 may also provide for burning of user information onto DVD 80, such as previously discussed for DVD burner 78 in FIG. 2. Media hardware device 90 may also provide the capability for playing media that contains games that are used in conjunction with a game controller and a television set or other appropriate display. In the same manner as for playing movies recorded onto a DVD, media hardware device 90 may provide for means of providing feedback to the rental service's computer 74 and information to customer database 40 about the user's use of the game media and the viewing of any customer specific content that was recorded onto the game media by the rental service.

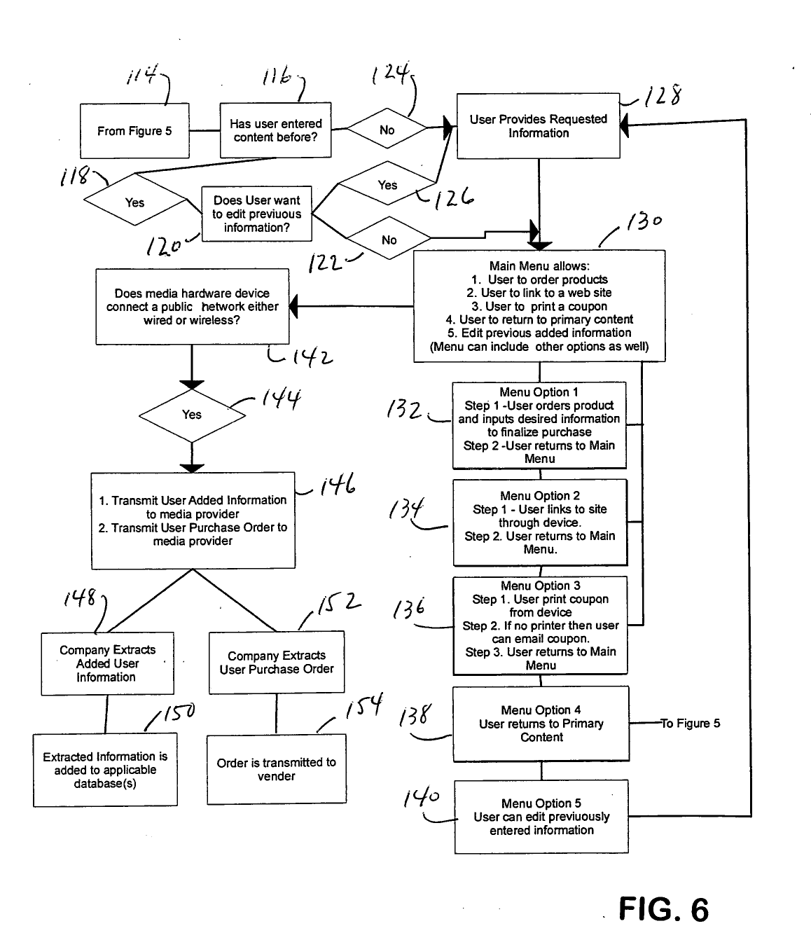

FIGS. 5 and 6 collectively illustrate an example of how a customer may interact with the added informational content, such as on tracks 81-83 of a video rental medium, such as on DVD 80 in FIG. 3. In the first step of block 100 of FIG. 5, the customer may begin playing or viewing of the rented product, for example, as previously described in block 54 of FIG. 1. The added informational content, such as on tracks 81-83 of DVD 80 of FIG. 3, will then begin to be viewed at block 102. As shown at block 104, the customer may be presented with the opportunity to request more information about the product or service, with a solicitation to purchase the product or service, or the like. This may occur at any time during the presentation of the added informational content, such as at the end of viewing of any of the tracks 81-83. As further noted in block 104, the interactive information provided by the customer may be written on the disk, as previously discussed with respect to block 56 in FIG. 1. If the user declines to participate interactively with the added informational content, block 106, the primary informational content, such a movie, may begin after any remaining added informational content is first viewed, block 108.

However, if the user elects to participate interactively with the added informational content at block 110, the process then passes by block 112 of FIG. 5 to blocks 114 and 116 of FIG. 6. If the user has previously entered content before (blocks 116 and 118) and does not wish to edit previously entered content (blocks 120 and 122), the process passes to a menu in block 130. If the user has not entered content before (blocks 116 and 124), or if the user has entered content before and wishes to edit the previously entered content (blocks 116, 118, 120 and 126), the user may provide the requested information at block 126. After doing so, the process passes to the menu block 130.

At block 130, a main menu may be presented to the user. This main menu may include a plurality of options, choices, or the like. In this example, the first option may be to order a product or service. If selected, the user may be invited to order the product or service, such as at block 132. The user may then input additional information, as needed, to finalize the purchase. The user may then be returned to the main menu at block 130.

If the user selects the second option of linking to a related website from the main menu of block 130, the user may be presented with this second option at block 134. After linking to the desired website, the user may return to the main menu. Similarly, if the user selects the third option from the main menu at block 130, the user may be presented with the menu of block 136. In this example, the user is invited to print a coupon or the user may be invited to receive a coupon via the internet at his/her email address. The user then returns to the main menu block 130.

If the user completes his/her interactive session with the added informational content, or if the user is not interested in continuing the interactive session, he/she may select the fourth option, block 138 and return to the primary content, or to any remaining added informational content, by going to block 108 in FIG. 5. The user may also select the fifth option, block 140, to return to block 128 where he/she may edit previously entered information.

Of course, the main menu of block 130 may contain more or fewer options, as desired or as needed. For example, other selectable options may include invitations to enter contests or sweepstakes, to obtain further information about a product or service, or the like.

As previously explained with respect to block 56 of FIG. 1, the user's device to play the rental movie may include writing or recording capability that provides information on the video rental medium that may be extracted upon return of the rental medium. Alternatively, or additionally, if the user's device to play the rental movie also is connected to a communications network that is either wired or wireless (blocks 142 and 144 in FIG. 6), information concerning the user's interaction with the added informational content may be directly communicated to the media provider, as indicated at block 146. Such information may include any purchase orders.

The media provider may then extract the added user information (block 148) and add any applicable extracted information to the appropriate customer database 40 or content database 44 (block 150). If the extracted information includes a purchase order (block 152), the order may be transmitted or otherwise communicated to the appropriate vendor or advertiser (block 154).

While particular embodiments of the invention have been shown and described, it will be obvious to those skilled in the art that various changes and modifications may be made therein without departing from the invention in its broader aspects.

1. A method of adding informational content to a rented video medium, said method comprising the steps of:
gathering information about a customer's preferences;
storing the customer's preferences in a memory;
selecting informational content to be added to the rented video medium based upon the customer's preferences; and
adding the selected informational content to the rented video medium.

2. The method of adding informational content to a rented video medium in accordance with claim 1 wherein the informational content includes advertising trailers.

3. The method of adding informational content to a rented video medium in accordance with claim 1 wherein the informational content includes disposable advertising trailers.

4. The method of adding informational content to a rented video medium in accordance with claim 1 wherein the step of selecting informational content to be added to the rented video medium is based upon selection criteria.

5. The method of adding informational content to a rented video medium in accordance with claim 1 wherein the step of selecting informational content to be added to the rented video medium is based upon customer specific data.

6. The method of adding informational content to a rented video medium in accordance with claim 1 wherein the step of selecting informational content to be added to the rented video medium is based upon data from similar customer profiles.

7. The method of adding informational content to a rented video medium in accordance with claim 1, said method comprising the additional steps of:
extracting customer information from the rented video medium upon return of the rented video medium; and
storing of the extracted customer information in a memory.

8. The method of adding informational content to a rented video medium in accordance with claim 7, said method comprising the additional steps of:
preparing reports, said reports including the number of times that the informational content was viewed by customers.

9. A system for adding informational content to a rented video medium, said system comprising:
a data processor for gathering information about a customer's preferences;
a customer database for storing the customer's preferences;
a content database for storing informational content;
said data processor selecting informational content from the content database to be added to the rented video medium based upon the customer's preferences; and
apparatus for adding the selected informational content to the rented video medium.

10. The system for adding informational content to the rented video medium in accordance with claim 9 wherein the informational content includes advertising trailers.

11. The system for adding informational content to the rented video medium in accordance with claim 9 wherein the informational content added to the rented video medium is based upon selection criteria.

12. The system for adding informational content to the rented video medium in accordance with claim 9 wherein the informational content added to the rented video medium is based upon customer specific data.

13. The system for adding informational content to the rented video medium in accordance with claim 9 wherein the informational content added to the rented video medium is based upon data from similar customer profiles.

14. The system for adding informational content to the rented video medium in accordance with claim 9, wherein said data processor extracts customer information from the rented video medium upon return of the video rental medium and the extracted customer information is stored in the customer database.

15. The system for adding informational content to rented video medium in accordance with claim 14, wherein said data processor prepares reports of number of times that the informational content was viewed by customers.

16. The system for adding informational content to rented video medium in accordance with claim 9 wherein the apparatus for adding the selected informational content to the rented video medium comprises a DVD burner.

17. A rental video medium, said rental video medium comprising:
a plurality of prerecorded informational content segments, said plurality of prerecorded informational content segments selected based upon a customer's preferences, and
a movie segment.

18. The rental video medium in accordance with claim 17 wherein the plurality of prerecorded informational content segments includes advertising trailers.

19. A method of enabling a customer to interactively respond to added informational content in a rented video medium, said method comprising the steps of:
adding informational content to the rented video medium;
presenting the customer with a menu of options upon playing of the added informational content; and
selecting one of the options in the menu by the customer.

20. The method of enabling a customer to interactively respond to added informational content in accordance with claim 19, said method comprising the additional steps of:
gathering information about the customer's preferences;
storing the customer's preferences in a memory; and
selecting informational content to be added to the rented video medium based upon the customer's preferences.

21. The method of enabling a customer to interactively respond to added informational content in accordance with claim 19, said method comprising the additional step of:
communicating to the supplier of the rented video medium the option selected by the customer.

22. The method of enabling a customer to interactively respond to added informational content in accordance with claim 19 wherein one of the options in the menu comprises the step of:
purchasing a product or service.

23. The method of enabling a customer to interactively respond to added informational content in accordance with claim 22 further comprising the step of:
communicating the order to a vendor of the product or service.

24. The method of enabling a customer to interactively respond to added informational content in accordance with claim 19 wherein one of the options in the menu comprises the step of:
linking to a website.

25. The method of enabling a customer to interactively respond to added informational content in accordance with claim 19 wherein one of the options in the menu comprises the step of:
printing a coupon.
